(19) United States
(12) Patent Application Publication
(10) Pub. No.: US 2025/0249425 A1
(43) Pub. Date: Aug. 7, 2025

(54) CONDUCTIVE LIQUID HYDROCARBON GAS PLASMA FOR MATERIAL AND CHEMICAL SYNTHESIS AND TRANSFORMATION

(71) Applicant: The Texas A&M University System, College Station, TX (US)

(72) Inventors: David Staack, College Station, TX (US); Howard Jemison, Houston, TX (US); Kunpeng Wang, College Station, TX (US)

(73) Assignee: The Texas A&M University System, College Station, TX (US)

(21) Appl. No.: 18/855,849

(22) PCT Filed: Mar. 31, 2023
(86) PCT No.: PCT/US2023/017074

§ 371 Date: Oct. 10, 2024

Related U.S. Application Data
(60) Provisional application No. 63/330,953, filed on Apr. 14, 2022.

(51) Int. Cl. B01J 19/08; B01D 53/02; B01J 19/00; C01B 3/24

(52) U.S. Cl. CPC B01J 19/088; B01J 19/0013; C01B 3/24; B01D 53/02; B01D 2256/16; B01J 2219/00103; B01J 2219/0809; B01J 2219/085; B01J 2219/0869; B01J 2219/0871; B01J 2219/0877; B01J 2219/0896; C01B 2203/0272; C01B 2203/0861; C01B 2203/0883

(57) ABSTRACT

A high voltage discharge between two electrodes generating a plasma is disposed within a reactor chamber. Hydrocarbon gas and conductive liquid are passed over one or more electrodes, such that the conductive liquid cools the electrodes and avoids fouling. Such a discharge may result in hydrogen gas and additional carbon containing coproducts which may be used, released, or sequestered.

### CROSS-REFERENCE TO RELATED PATENT APPLICATIONS

The present application claims the benefit of priority to U.S. Provisional Application No. 63/330,953, filed Apr. 14, 2022, the disclosure of which is incorporated herein by reference in its entirety.

### BACKGROUND

The present invention relates generally to the fields of energy production, gas to liquid fuel conversion, macro and nanomaterial synthesis, hydrogen production and carbon sequestration.

### BRIEF DESCRIPTION OF THE DRAWINGS

FIG. 1 is a cross sectional diagram of a hydrocarbon gas reactor, in accordance with various embodiments.

FIG. 2 is another cross sectional diagram of a hydrocarbon gas reactor, in accordance with various embodiments.

FIG. 3 is yet another cross sectional diagram of a hydrocarbon gas reactor, in accordance with various embodiments.

FIG. 4 is a block diagram of a system to process hydrocarbon gasses is provided, according to some embodiments.

FIG. 5 is another block diagram of a system to process hydrocarbon gasses is provided, according to some embodiments.

FIG. 6 is yet another block diagram of a system to process hydrocarbon gasses is provided, according to some embodiments.

FIG. 7 is a sequestration portion of a system 700 to process hydrocarbon gasses, according to some embodiments.

FIG. 8 is another cross sectional diagram of a hydrocarbon gas reactor, in accordance with various embodiments.

FIG. 9A is a cross sectional view of hydrocarbon reactor, in accordance with some embodiments.

FIG. 9B is an isometric view of the hydrocarbon reactor of FIG. 9A, in accordance with some embodiments

### SUMMARY

Some embodiments relate to a multiphase non-equilibrium plasma hydrocarbon reactor. The reactor can include a first electrode, configured to receive a first conductive liquid from a first injection port, and energize said first conductive liquid to a first voltage. The reactor can include a second electrode, configured to receive a second conductive liquid from a second injection port, and energize said second conductive liquid to a second voltage. The second electrode can be a distance from the first electrode. A difference between the first voltage and the second voltage can exceed a dielectric breakdown of a gas disposed within the reactor for the distance.

In some embodiments, the reactor can include a gas injection port configured to deliver the gas to the hydrocarbon gas reactor. In some embodiments, the gas injection port is one of the first or second electrodes. In some embodiments, the gas disposed within the reactor is a non-oxidizing gas comprising hydrocarbons. In some embodiments, the hydrocarbons comprise natural gas. This natural gas may be raw gas from a well, gas from a natural gas gathering line, or natural gas from a distribution line. In some embodiments the hydrocarbon gas can be attained from another process such as a gasifier, biogenesis, or other hydrocarbon gas production processes. The hydrocarbon gas thus may contain non-hydrocarbon impurities as is typical of such sources. In some embodiments, a dielectric sheath, in conjunction with the first injection port, delivers the first conductive liquid to the first electrode. In some embodiments, the reactor can include a first outlet vent for the gas, and an ignition source configured to ignite the vent gas. In some embodiments, the reactor includes a bypass vent, configured to vent the gas prior to its introduction to the reactor. In some embodiments, the reactor includes a hydrogen power generator such as a fuel cell or turbine, configured to receive hydrogen generated within the reactor to generate electrical energy. In some embodiments, the hydrogen electrical energy generator comprises at least one of a pressure swing absorption (PSA) system, a temperature swing absorption (TSA) system, a membrane purifier, or a dryer purification system which can condition the gas to a specification corresponding to the energy generating system. In some embodiments, the reactor is configured to generate swirling of radial plasma and liquid along an interior surface of a sidewall thereof. In some embodiments, the reactor includes a plurality of magnets disposed around an exterior surface of the sidewall thereof. In some embodiments, the reactor is configured to adjust a flow rate of the first conductive liquid or the second conductive liquid responsive to a conductivity of the respective conductive liquid.

Some embodiments relate to a system. The method can include a multiphase non-equilibrium plasma hydrocarbon reactor. The reactor can include a first electrode, configured to receive a first conductive liquid from a first injection port, and energize said first conductive liquid to a first voltage. The reactor can include a second electrode, configured to receive a second conductive liquid from a second injection port, and energize said second conductive liquid to a second voltage. The second electrode is a minimum distance from the first electrode. A gas injection port can be configured to deliver a hydrocarbon gas to the reactor. A difference between the first voltage and the second voltage can exceed a dielectric breakdown of the hydrocarbon gas disposed within the reactor for the distance.

In some embodiments, the first injection port and the second injection port are different ports. In some embodiments, the gas injection port is one of the first or second electrodes. In some embodiments, the system includes a plurality of magnets disposed around an exterior surface of a reactor sidewall, the plurality of magnets configured to generate swirling of radial plasma in combination with an electric field between the first and second electrodes.

Some embodiments relate to a method. The method can include receiving, by a multiphase non-equilibrium plasma hydrocarbon reactor, a first conductive liquid at a first injection port. The method can include energizing, by a first electrode of the reactor, the first conductive liquid at a first voltage. The method can include receiving, by the reactor, second conductive liquid at a second voltage, the second conductive liquid separated from the first conductive liquid by a distance. The method can include receiving, by the reactor, a hydrocarbon gas. A difference between the first voltage and the second voltage can exceed a dielectric breakdown of the hydrocarbon gas so as to ionize the hydrocarbon gas.

In some embodiments, the method includes receiving, from the reactor, a conductive liquid therefrom. In some embodiments, the method includes separating a first portion of conductive particles from the conductive liquid, and thereafter injecting the separated conductive liquid into the reactor. In some embodiments, the method includes receiving, from the reactor, the second conductive liquid. In some embodiments, the method includes cooling, by a heat exchanger, the second conductive liquid. In some embodiments, the method includes injecting cooled second conductive liquid into the reactor.

### DETAILED DESCRIPTION

Although hydrocarbons such as methane (e.g., bio-methane) and other hydrocarbon gases include hydrogen atoms, the formation of H₂ or other materials or energy from these hydrocarbons presents challenges. Some of those challenges involve carbon released into the atmosphere, which may have negative environmental and regulatory consequences. For example, carbon monoxide may be released from a methane-steam reforming reaction according to the reaction CH₄+H₂O<=>CO+3H₂. In some reactors, carbon dioxide may be released from combustion processes used to encourage the above mentioned reaction. Passing methane into a plasma discharge may cause various chemical reactions resulting in the formation of H₂. For example, a reactor chamber may be filled with a substantially non-oxidizing gas, such as methane, and at least one pair of electrodes may be energized to a high voltage, sufficient to result in the dielectric breakdown of a gap between the two electrodes. The gap may be about 10-20 mm, and the electrodes may be energized to about 10-20 kV potential (e.g., by an alternating current or direct current source). One skilled in the art will understand that the voltage and gap may be adjusted depending on the dielectric breakdown of the gas between the electrodes (e.g., pressure, composition, etc.).

The plasma discharge can operate in a manner such that non-equilibrium chemical reactions occur. The non-equilibrium condition can be maintained in the presence of an electric field high enough that electrons have sufficient energy to initiate non-thermal ionization, dissociation, and chemical excitation. Reduced electric fields in these non-equilibrium embodiment can range from dozens to hundreds of Townsend (Td), in some embodiments. In the non-equilibrium conditions, reaction chemistries may vary from those in equilibrium systems. For example, some stream-methane-reforming (SMR) processes can produce with a hydrogen to carbon monoxide ratios of about 3 to 1 (H₂:CO=3:1). Various embodiments of non-equilibrium multiphase plasma reactors (e.g., reformers) can range, for example, from about 3 to 1 to about 10 to 1 for some operating conditions.

In some embodiments, higher water temperatures (e.g., in excess of 30° C.) or more turbulent water flow may incorporate more steam into the plasma discharge zone, and generate relatively low H₂:CO ratios. In some embodiments, lower water temperatures (e.g., less than 30° C.) or less turbulent water flow may incorporate less steam into the plasma discharge zone, and generate relatively high H₂:CO ratios. Moreover, reactors generating relatively high H₂:CO ratios can employ lower water temperatures (e.g., based on water volume or a heat exchanger), higher system pressures (e.g., as controlled by headspace valves), salt water solutions (e.g., as controlled by addition of salts or other particles), more dynamic plasma discharges, and a greater quantity of non-thermal plasma. Reactors employing a conductive liquid that contains less oxygen than water, for example a conductive oil, can be employed to generate gaseous products having relatively high H₂:CO ratios, which may reduce the carbon dioxide emissions impact of the overall process.

An ensuing dielectric breakdown may result in plasma discharge between the electrodes, such that when a hydrocarbon, such as methane gas, is passed into the discharge, the hydrocarbon may undergo various chemical reactions resulting in a product of H₂, various oxygenates, or carbon particles which may thereafter be separated, sequestered or otherwise used.

The operating voltage of the plasma may be less than the original energized voltage, for example 500V to 3 kV. In the gas phase, hydrogen can be generated along with other species such as gaseous hydrocarbons (e.g., alkane or alkene). In some embodiments, hydroxyl radicals and oxidized and partially oxidized compounds can be formed, such as where water is used as a liquid electrode. In the liquid and solids phase, for example, co-products such as carbon solids, polymers, alcohols, etc. may be sequestered and/or used. The hydrocarbon (e.g., natural gas) may be passed into the reactor via a gas injection port. In some embodiments one or more electrodes may be hollow/cannulated to allow the gas to pass through the electrode towards the plasma discharge.

Products of the system can occur in the gas phase, the liquid phase, and the solid phase. For example, short chain alcohols like methanol, ethanol, propanol, propenol, and ketones can be produced therein. In the production of hydrogen from hydrocarbons, gaseous carbon oxides or carbon solids may be produced. Coke (a grey, hard, high carbon content solid), is a potential product of hydrocarbon processing in the absence of oxygen. Upon a formation thereof, this coke may present a challenge to transport out of the reactor and prevent fouling (e.g., the accumulation of unwanted material on surfaces such as electrodes). Maintenance cycles on the equipment may be performed to remove the coke, and other accumulations. The non-thermal multiphase plasma reactor with liquid electrodes can transport produced solids out of the reactor to obviate or reduce such maintenance. The non-equilibrium plasma, due to high intensity of processing reactions and the short residence time of particle within the reaction zone, can produces solid particles which are about 10 nm to about 1000 nm in scale, in some embodiments. Such solids can cover a large surface area, such as an electrode surface when not transported away. A non-limiting composition table of some example hydrophobic, nano-graphene solids attained by SEM-EDS follows; other solid compositions and structures may be formed from varying process temperature, pressure, current, solution salinity, flow rates or so forth.

| Element | Weight % | Atomic % |
|---|---|---|
| C K | 94.92 | 96.24 |
| O K | 4.7 | 3.58 |
| Na K | 0.16 | 0.09 |
| Al K | .021 | 0.09 |

In some embodiments, the co-products can foul the reactor by forming particles over the electrodes, as in various thermal pyrolysis and electric discharge pyrolysis systems. Fouling can occur when particles collect and build up on surfaces preventing them from having the intended geometry or surface properties (e.g., electrical conduction). For example, fouling with conductive carbon could cause dielectric surfaces to become conductive changing the electrical discharge. In some embodiments, fouling is prevented by convecting solids away from surfaces using a (conductive) liquid as an electrode for the discharge. The conductive liquid can include water, molten metal, or oil. The conductive liquid can include various dissolved components to adjust a conductivity thereof. Moreover, the quantity of such dissolved components can be adjusted or maintained. Like a metallic electrode, a conductive liquid electrode can serve as the electric circuit electrode for the boundary of the plasma. A portion of the liquid may volatize, becoming a component of the plasma discharge. The volatized portion may depend and be controlled, correlating to a boiling point of the liquid electrode, the specific heat of the liquid electrode, or the like.

In some embodiments, the liquid electrode includes water, the evaporation of a portion of the water electrode can add steam or methane reforming and add water shift reactions to the chemistry of the system. In some embodiments, the liquid electrode includes water along with salt wherein this evaporation injects alkali, alkaline, or metallic elements into the plasma discharge (for example Na, Ca, Mg, K). These elements can significantly lower the electric field required to sustain the plasma and improve the efficiency of plasma generation (e.g., by lowering the electric field to sustain the plasma at the same current by 10%-50% according to some embodiments), relative to other elements which may employ additional energy to ionize (e.g., carbon).

Conductive liquid may be passed over one or more of the electrodes which may clear any fouling (e.g., carbon solid fouling) on the electrodes, cool the electrodes, etc. In some embodiments, conductive liquid may be passed over one or more of the electrodes during operation, such that the conductive liquid may act as the electrode. For example, the conductive liquid may comprise a salt or other material (e.g., NaCl, carbons solids, etc.) which may increase the conductivity of the conductive liquid, and may allow the conductive liquid to operate as an effective extension of the electrode. Advantageously, such an embodiment may result in cooling the chamber comprising the electrodes during operation, remove and/or avoid the accumulation of carbon along solid electrodes, and may further result in additional availability of vapor, which may increase the production of hydrogen (e.g., by the methane-water reaction, in the case of a water containing electrode). Further, such an embodiment may use the turbulent and/or vortex motion of the conductive liquid to remove carbon fouling, polymers, and/or other solids from the chamber (e.g., through a collection area, by allowing various solids to precipitate from solution, by passing the conductive liquid through a filtering element, etc.). The various conductive liquid streams in these example may be held at significantly different potentials and electrically isolated upstream to ensure a high voltage discharge between the conductive liquid electrodes.

In some embodiments, various mechanical features of a dielectric sheath, the electrodes, and various additional components (e.g., fans, magnets, heaters, etc.), may be employed to direct the flow of the conductive liquid, a hydrocarbon gas, impart forces on the plasma, and to accelerate or retard various chemical reactions. In some embodiments the electrode, dielectric, and cannula (e.g., various injection ports) may be placed relative to one other to increase the plasma unprocessed gas interaction. For example a dielectric sleeve may extend beyond the end of a hollow electrode to force plasma attachment point in an interior surface of the electrode. A mix of axial and swirling flow may be used to convect gas through the discharge to achieve a desired residence time of the gas within the active discharge zone. Similarly, a magnetic field may be applied to the plasma to convect the plasma discharge through the gas. A permanent magnet or electromagnet can generate an (e.g., axial) magnetic field. Combined with the radial electric field, E, and radial current, J, between the electrode on the outer wall and the electrode on the centerline, a Lorentz force in the JxB azimuthal direction can be generated. This can cause plasma to rotate in the azimuthal direction (e.g., swirl). This motion can increase a rate of non-equilibrium plasma reactions and further distribute the formation of carbon particle synthesis, which may prevents fouling particles from accumulating.

Although many embodiments will orient the upper and lower electrodes vertically, as depicted in the various figures herein, some embodiments, including various embodiments comprising fluidic electrodes (i.e., where a terminal portion of the electrode is a fluid such as water), may orient the electrodes vertically or otherwise. Additionally, the positions of the upper and lower electrodes may be reversed, either mechanically, or electrically. Thus, the upper and lower nomenclature of the electrodes is merely intended to refer to the figures herein, and not limit this disclosure, which contemplates the upper and lower electrodes in various positions, and with various relative polarizations. Further, electrodes may similarly be termed as first and second (and third and fourth, and inner and outer, and so on). These designations are not intended to limit the location, polarization, order of manufacture or energizing of the various electrodes, and are merely for clarity of reference. For example, in another embodiment the discharge may occur between a central/axially located electrode and the inner wall of a cylindrical annular with the discharge being predominantly radial in direction. Conductive liquid can be outer annulus through tangential injection or swirling motion. The conductive liquid may also flow radially out of the central electrode. Swirling may refer to a circular or spiral rotation within the reactor body. For example, any fluid (e.g., vapor or liquid fluid) along with any plasma swirl responsive to magnetic forces, electrical forces, gas input velocity, conductive liquid input velocity, mechanical rotation, or so forth.

Conductive liquid temperature may be controlled by adjusting a volume of water injected into or removed from the reactor. For example, for a water electrode, a temperature of less than 30° C. may be maintained my increasing a flow rate of water through the reactor, or increased by lowering a flow rate of water through the reactor in order to control its partial pressure in hydrocarbon gas/water vapor mixture. This may reduce oxidative products including CO and CO₂ which are products of plasma steam reforming of hydrocarbons. Similarly the pressure inside of the reactor can be increased such that there is less evaporation of the liquid electrode materials. Again in the example of a water electrode this increase in pressure will reduce the production of CO and CO₂ relative to the production of H₂. All of the liquid or only part of the liquid evaporates upon encountering the heat and plasma in the reactor, thus the flow rate can be determined in combination with a rate of vapor entering of leaving the reactor.

Likewise, a flow rate of the conductive fluid can be adjusted to control a conductivity thereof. For example, a settling tank, filter, skimmer, or other separator for particulates such as salts, carbon solids or the like can remove particles from the water such that adjusting the flow rate of the conductive liquid between the reactor and the separator can control a conductivity of the conductive liquid. The reactor can adjust the flow rate to control the flow rate such that liquid flow is effective to remove fouling on the electrode, control a temperature of the reactor, etc. Flow rate can be controlled such that conductive loss through the liquid is maintained below a threshold. For example, the reactor can include or interface with a controller configured to execute instructions of a non-transitory media. The controller can be in network communication with various valves disclosed herein, along with sensors to determine temperature, pressure, conductivity, and other properties of the reactor, such as the conductive liquid, and can cause the various valves to actuate responsive to comparisons of detected values to thresholds.

In some embodiments, the material of the container containing the conductive liquid is formed from conducting components or dielectric components. Similarly, the hollow tube convecting the conductive liquid may be conducting or dielectric. Construction of a circuit where all conductive liquid contacting materials are either dielectrics or plasma may be configured such that no metals or solid conductors contact the conductive liquid. Such a configuration may, advantageously, ease the manufacture of embodiments having electrochemical reactions at electrodes (e.g., both anodic and cathodic reactions) which may be suppressed to avoid chemical reactions of metallic ions. Alternatively or in addition, the vessels containing the conductive liquid flows may be made of specific conductors so as to specifically introduce certain metallic ions for benefit of the products generated. For example, one skilled in the art would be versed in the field of nanotube growth, and would understand that Ni metal particles may serve as seeds for carbon nanoparticle synthesis of various geometries. In some embodiments, Ni ions in solution at the conductive liquid-plasma interface may serve as seeds for nanotube growth through one or more chemical pathways.

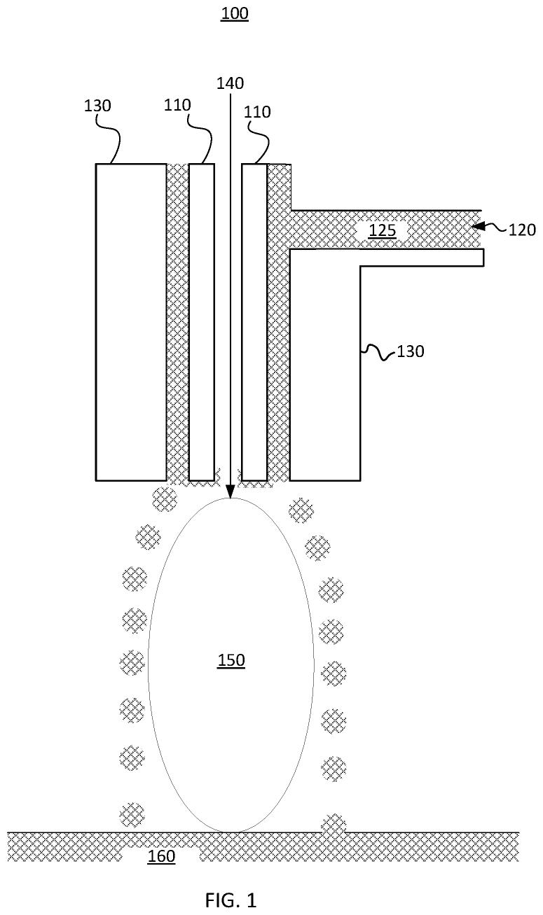

Referring to FIG. 1, a cross sectional diagram of a hydrocarbon gas reactor 100 is provided in accordance with various embodiments. The reactor 100 comprises a hollow upper electrode 110, a conductive liquid injection port 120, and a dielectric sheath 130. The upper electrode 110 is connected to a first voltage, such as through a bus bar, wire, etc. In some embodiments, various electrodes may be energized from charging conductive liquids 120 with an electric charge and thereafter allowing droplets of the conductive liquid 125 to fall onto the bottom electrode 160 which may, advantageously, allow for electrical isolation of the electrodes. The hollow center of the upper electrode 110 may be configured to pass hydrocarbon gas from a storage facility, utility, or down well location into the reactor chamber along a flow path 140.

The upper electrode 110 may comprise one or more conductive elements. For example, a first metallic element may be connected to a first voltage source, and a second fluidic element may be a conductive liquid 125, such as an aqueous solution comprising water, and additives thereto to adjust the viscosity, conductivity, etc. Such an aqueous solution is herein referred to as water, for ease of reference. For example, salts (e.g., NaCl) may be added to the water to increase conductivity of the water, such that water in contact with the first electrode (i.e., the first water) may be energized to about the first voltage.

In some embodiments, the conductive liquid can include a molten metal (e.g., may be or include cerium, gallium, a combination thereof, or the like). The metal may be liquid at near ambient temperatures (e.g., less than 100° C. such as less than 30° C.) which may lower an energy usage of the reactor. In some embodiments, the conductive liquid includes a hydrocarbon liquid (which may nominally be low conductivity) with carbon or metallic conductive particles in the solution. These can include micro or nanoparticles in the solution. The particles could be added to the liquid or synthesized within the system and recycled within the liquid flow. The conductive liquid can include a mixture of various liquid described herein, and the like.

The lower electrode 160 is depicted as a conductive liquid electrode which may cover a conductive element (not depicted) to ground the conductive liquid (e.g., a ground plane, a bus bar, a ground strap, etc.). A second conductive liquid injection port may provide conductive liquid to the lower electrode. For example, in FIG. 1, the second conductive liquid port is the upper conductor (i.e., the first conductive liquid may fall to the second conductive liquid, either directly as droplets, or after vaporizing and re-condensing). The second electrode 160 may be energized to a second voltage, which, relative to the first electrode, exceeds the dielectric breakdown voltage of a gap (i.e., a minimum distance) between the upper 110 and lower electrodes 160 (including the conductive liquid 125 included in the electrodes 110, 160), so as to form a plasma 150. The opening at the center of the hollow upper electrode 110 may be used to pass hydrocarbon gas (e.g., methane) to the gap between the upper and lower electrodes, such that the gas enters the plasma 150 at a controlled rate, inducing various chemical reactions including the formation of H₂. The reactor may be a multiphase reactor, wherein material such as a hydrocarbon can be react in a plurality of phases (e.g., solid phase, liquid phase, gas phase, and plasma phase).

The dielectric sheath 130 may provide mechanical support to the upper electrode 110, such as adhering the upper electrode 110 to an upper or side surface of the reactor, providing fluid retention for the electrode (e.g., to maintain the conductive liquid along the electrode). The flow rate of the conductive liquid may be configured to maintain the conductive liquid along the electrode, maintain a desired level of conductive liquid vapor, etc. Further, the conductive liquid may comprise various thickening agents, detergents, etc. to adhere the conductive liquid to electrodes, avoid an electrical connection (e.g., a short circuit) between the first and second electrode in addition or as an alternative to controlling the conductive liquid flow, surface smoothness, upper or lower electrode position, etc.

In some embodiments, the amount of salt, particles, or other additives added to the conductive liquid may control the conductivity thereof, to control the formation of various substances. For example, the addition of NaCl at a concentration of about 3% may result in a relatively large proportion of carbon solids formed, whereas NaCl at a concentration of about 0.1% may result in a relatively large proportion of polymers being formed. In oxygen including conductive liquids such as water, a portion of the conductive liquid may form CO or CO₂. Hydrocarbons including conductive liquids can reduce oxidation and contribute to solid particle or hydrocarbon gas production. One skilled in the art will understand that the creation of various coproducts may vary according to a pressure, temperature, the amount, flow rate, and composition of the hydrocarbon gas, and the conductive liquid. Various coproducts may be created corresponding to various inputs. The conductive liquid may be delivered onto the first conductor by a conductive liquid injector which may inject conductive liquid, through the first conductive liquid injection port 120 from outside the reactor and/or recycle conductive liquid from the reactor.

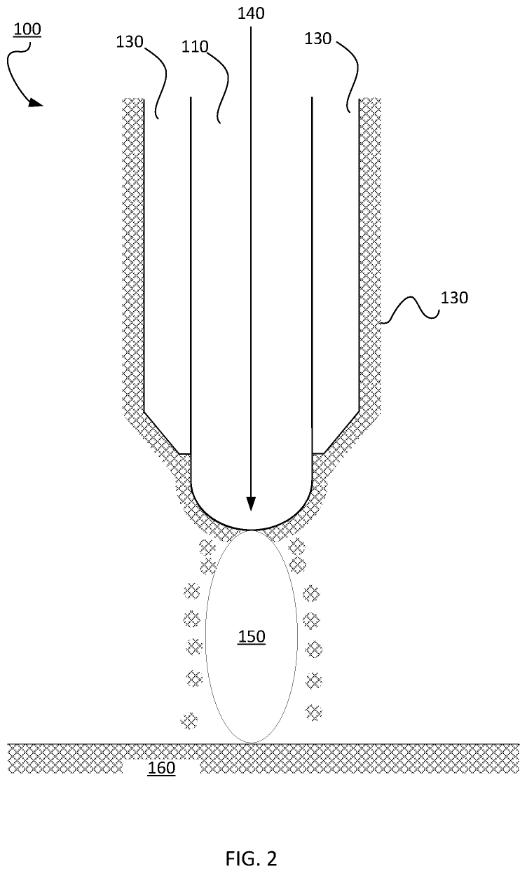

Referring to FIG. 2, another cross sectional diagram of a hydrocarbon gas reactor 200 is provided, according to some embodiments. As depicted, the conductive liquid 125 is received around an outer perimeter of the dielectric sheath 130, which may, advantageously, simplify the design of the upper electrode 110. The dielectric sheath may be chamfered or otherwise formed to pass the conductive liquid 125 to along the edge of the electrode (e.g., along the surface of the upper electrode, through channels in the electrode configured to receive the conductive liquid 125, etc.). Advantageously, such embodiment may avoid the plurality of generally concentric openings found in the upper electrode of FIG. 1.

The upper electrode 110 can be a cannula (e.g., a stainless steel capillary electrode) configured to receive a hydrocarbon gas including natural gas (e.g., ethane, methane, propane, etc.) A flow path 140 of the hydrocarbon gas depicts a net migration of the gas into the chamber, which may correspond to a pressure gradient between a source of the gas and the reactor.

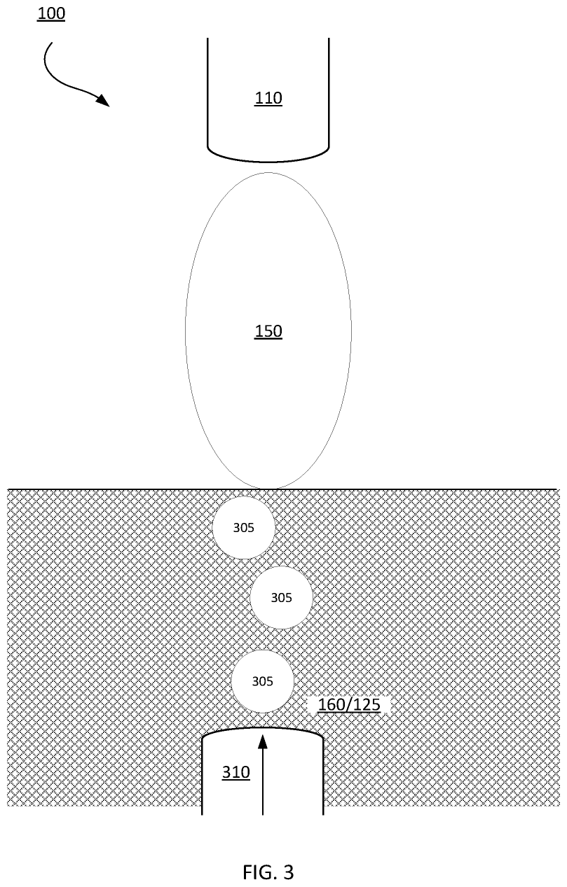

Referring to FIG. 3, yet another cross sectional diagram of a hydrocarbon gas reactor 100 is provided, according to some embodiments. As depicted, the hydrocarbon gas 305 is introduced from a lower electrode 160, which may, advantageously, simplify the construction of the upper electrode. Hydrocarbon gas 305 is guided towards the upper electrode through a hydrocarbon gas injector 310. In some embodiments the hydrocarbon gas injector 310 may be a conductive element energizing the conductive liquid which is, or is in contact with, the second electrode 160, to a second voltage. In some embodiments, the conductive liquid 125 may be otherwise energized to a second voltage, and the hydrocarbon gas 305 may be guided otherwise (e.g., by a nonconductive port such as glass or plastic, by fluid dynamics such as a vortex within the conductive liquid, etc.). In some embodiments, a plurality of upper electrodes 110 or an upper electrode 110 of large cross sectional area may obviate the need to guide the methane, except by the selection of a suitable insertion point. One skilled in the art will understand that various elements of the depicted embodiments may be adjusted, modified, and substituted therebetween, and that various mechanical pressures, etc. or other mechanisms may provide a pair of fluidic electrodes conductive liquid at a first controlled rate, and introduce a controlled flow of hydrocarbon gas at a second controlled rate, and may maintain or adjust the distance between those electrodes, the first rate, the second rate, etc.

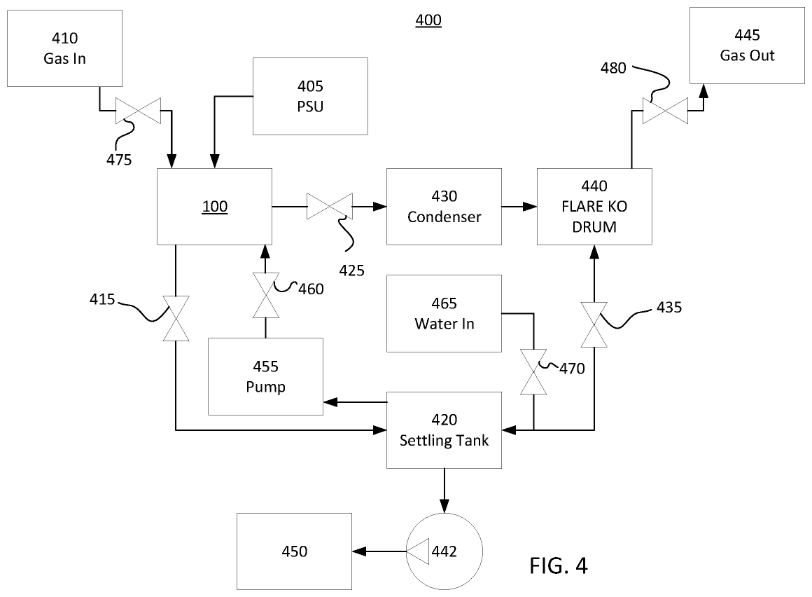

Referring to FIGS. 4-6, carbon sequestration systems are provided, according to various embodiments. The systems can be employed for natural gas flaring or other gas sources. Natural gas may be processed as an incidental byproduct (e.g., incident to oil extraction), and may be released to the atmosphere, which may be undesirable (e.g., for environmental and/or regulatory reasons). The natural gas may comprise a plurality of components including methane. To discriminate between natural gas as originally constituted and later processed forms, the originally constituted substance may be termed as associated gas or raw natural gas. The raw natural gas is often combusted, which may control the pressure of the natural gas (e.g., at an oil extraction site), but may also release carbon dioxide, and un-combusted methane. Some embodiments may process natural gas (e.g., comprising methane) by any of the methods disclosed herein. In some embodiments, the hydrocarbon gas is biological in origin (e.g. bio-gas from an anaerobic digester). Thus, at least a portion of the raw natural gas may be converted into H₂, carbon solids, carbon-containing polymers, and additional carbon containing chemicals in aqueous solution (e.g., alcohols, ketones, aldehydes, fatty acids, etc.). New products may also separate (e.g., preferentially separate) to absorb in the solid phase, or an immiscible liquid phase (e.g., an oil phase with condensable alkanes, alkenes, etc.) as well as various gaseous products (e.g., acetylene, carbon monoxide, etc.). The various products may thereafter be captured for reuse or further processing, or may be ignited (e.g., by an ignition source such as a pilot light or an electric igniter) as a flare which may satisfy safety concerns or regulatory concerns. Advantageously, since at least a portion of the methane is converted to H₂, and at least a portion of the carbon (e.g., the carbon solids) is made available for sequestration, the resulting flare may emit lower CO₂ than raw natural gas. In some embodiments, an additional (e.g., failsafe) carbon flare emission site may be present which may allow continued venting and, in some embodiments, flaring, of the raw natural gas.

Referring specifically to FIG. 4, a block diagram of a system 400 to process hydrocarbon gasses is provided, according to some embodiments. A power supply unit 405 provides electricity to a hydrocarbon reactor 100. The power supply unit 405 can include a solar array, grid based energy, or another energy source (e.g., natural gas or oil based energy source). The hydrocarbon reactor 100 can receive hydrocarbon gas from a hydrocarbon gas input source 410 which may be a down well source, anaerobic digester, or another source. The hydrocarbon reactor 100 can be intermediated by one or more gas input valves 475. As the hydrocarbon reactor 100 operates, a fluidic electrode material can accumulate carbon or other materials therein. The hydrocarbon reactor 100 can connect to a settling tank 420 or other processing to control (e.g., remove or add) accumulated material. A reactor fluid outlet valve 415 can control a rate of fluid removed from the hydrocarbon reactor 100 which may control a content of the reactor fluid. The settling tank 420 can separate fluid, entrained gasses, and particulate matter and can include filters, separators, skimmers, or the like. A pump (e.g., clarified liquid pump) can return fluid to the reactors. A reactor fluid inlet valve 460 can control a rate or pressure of fluid return. The settling tank 420 can receive the water from a water source 465, through a water source valve 470. As described above, the various references to water can be replaced by various conductive liquids such as metals or oils having macro or nanoparticles disposed therein. For example, the water source 465 may be a molten metal source 465.

The hydrocarbon reactor 100 can supply hydrocarbon gas to a condenser 430 via a reactor outlet valve 425. The condenser 430 may output gas to a knock-out (KO) drum 440, which may separator vapors, gas, and entrained fluids. The entrained fluids and condensed vapors may be returned to the settling tank by a KO drum fluidic valve 435. The gas may be output via a gas output valve 480 to a gas output 445 which may include a flare, gas storage, energy production, or the like. Solids from the settling tank can be passed through a pump 442 (e.g., a carbon slurry pump) for sequester or otherwise dispose of carbon containing compounds at a storage location 450.

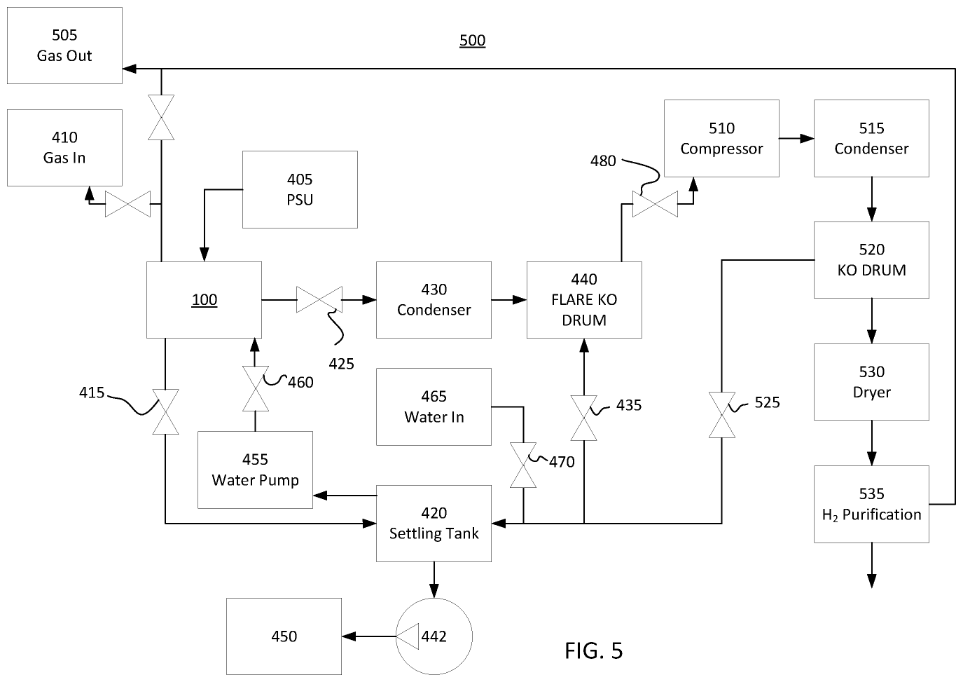

Referring specifically to FIG. 5, another block diagram of a system 500 to process hydrocarbon gasses is provided, according to some embodiments. The system 500 includes a gas output 505 which can receive a refined hydrocarbon gas such as hydrogen. The system 500 can include many of the various components of FIG. 4, along with a second stage KO drum 520. The second stage KO drum 520 can receive an output from the first stage KO drum 440 of FIG. 4, which may be intermediated by a compressor 510 and condenser 515 to further remove vapor, fluids, or other content. Such fluids can be returned to the settling tank 420 through a second stage fluidic valve 525. The gas may further pass through a dryer 530 and H₂ based purification portion 535 (e.g., a membrane purifier). Purified gas (e.g., H₂ gas) can be provided from the purification portion 535 and other portions of gas can be conveyed to the gas output 505 for a flare or other disposition.

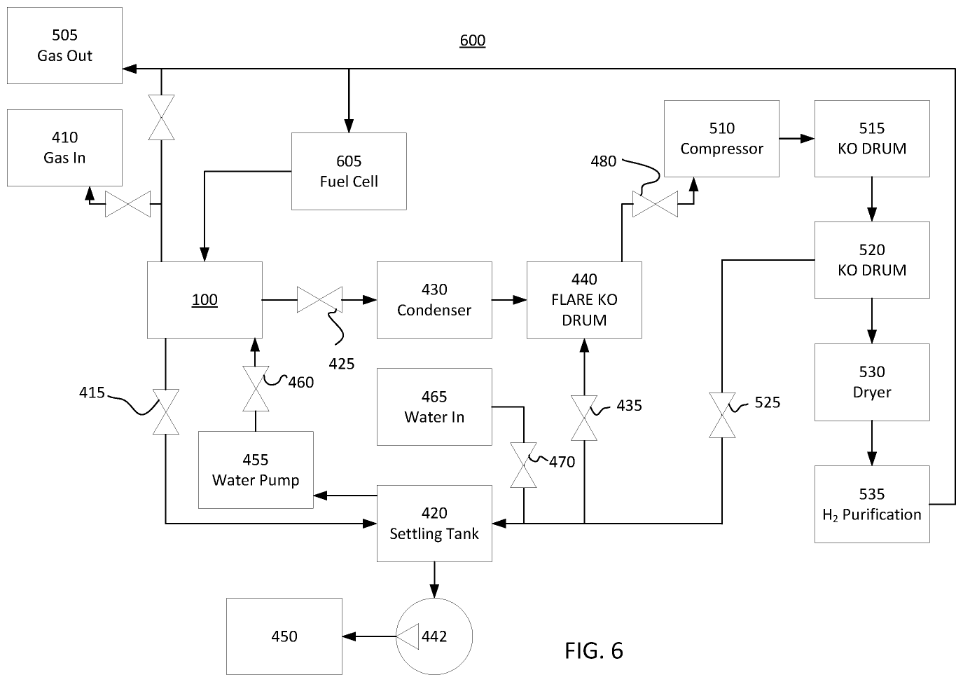

In some embodiments, a portion of the processed natural gas may be used to generate electric energy, such as through the use of an H₂ fuel cell or hydrogen turbine engine and generator. Advantageously, such a power source may supplement or obviate the need for grid-supplied energy to operate the reactor. A surplus of electrical energy (greater than that to power the plasma discharge) can also be produced and sold or used in other processes. Referring specifically to FIG. 6, such a fuel cell 605 can receive an output from the purification portion 535 of the system, and may supply energy therefrom to the hydrocarbon reactor 100.

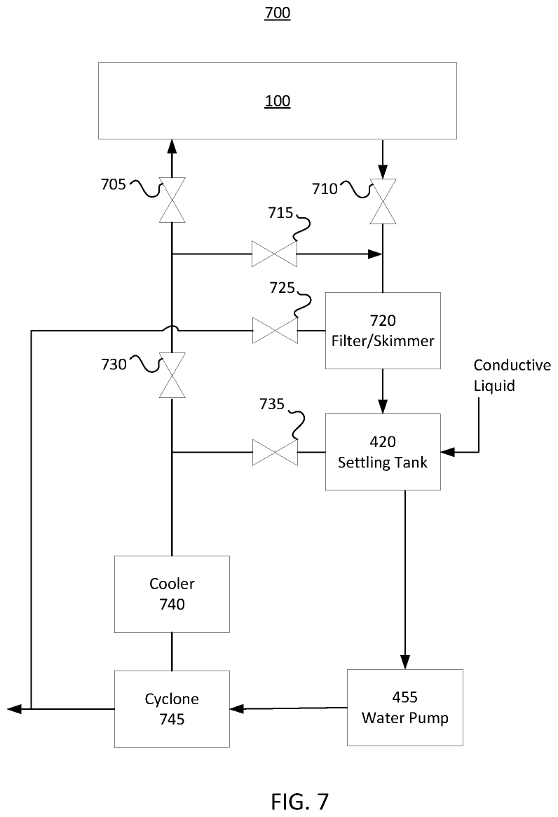

FIG. 7 depicts a sequestration portion of a system 700 to process hydrocarbon gasses, according to some embodiments. The sequestration portion can be employed with other systems such as the systems depicted in FIGS. 5, 6, and 7. Indeed, the various embodiments provided herein can be substituted, modified, and otherwise combined.

A reactor fluidic inlet valve 705, outlet valve 710, and transfer valve 715 can maintain a flow rate into and out of the reactor. A filter, skimmer, or other separator can receive fluid from the outlet valve 710 or transfer valve 715, and provide a first portion of carbon (e.g., low density solids) for sequestration. Other material can pass to the settling tank 420. The settling tank can receive other fluids including conductive liquids from the reactor or other sources. The settling tank 420 can provide the material to a water pump 455 or a cooler 740 in series with a cyclone 745 (e.g., hydrocyclone) to densify carbon which can thereafter be sequestered.

The depicted systems 400, 500, 600, 700 are not intended to be limiting and various elements may be added, omitted, substituted, or modified. For example, a vapor wash drum can intermediate the solids settling tank 420 from the conductive liquid supply, and return a portion of vapor or liquid to a KO drum 440. The vapor wash drum and the KO drum 440 can be intermediated by a condenser 430. A heat exchanger can reduce a temperature of the conductive liquid and return the cooled conductive liquid to the reactor 100. Some embodiments may omit a flare and may include a gathering line for all or all non-H₂ gas.

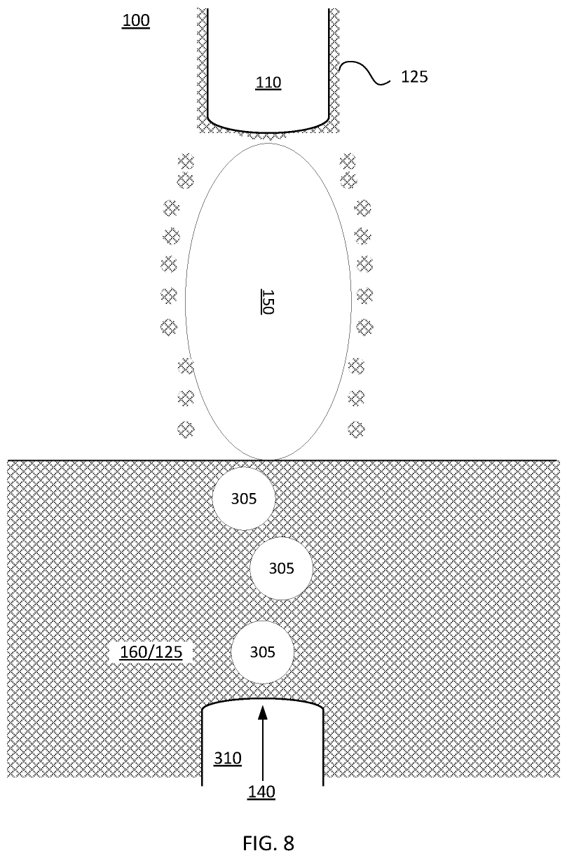

FIG. 8 depicts another cross sectional view still, of hydrocarbon reactor 100, in accordance with some embodiments. A lower electrode 160 can provide a hydrocarbon gas along a same flow path 140 as depicted in FIG. 4. An upper electrode 110 can include a conductive liquid 125. For example, the reactor of FIG. 8 can be a same reactor of FIG. 4, wherein a surface of both electrodes 110, 160 comprise a conductive liquid such as molten metal.

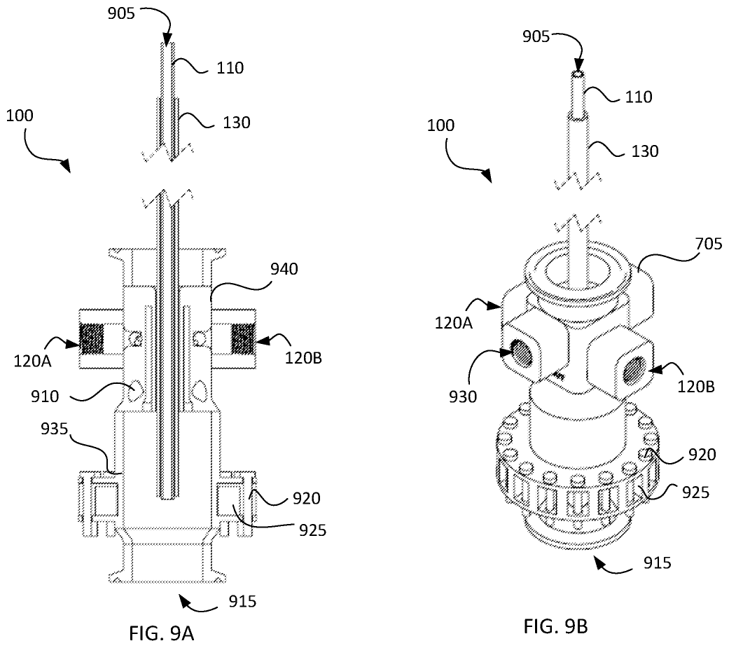

FIG. 9A depicts a cross sectional view of hydrocarbon reactor, in accordance with some embodiments. A gas injection port 905 of an upper electrode 110 provides hydrocarbon gas to a reactor body 940. The gas injection port 905, like other ports herein, can receive various amounts or pressures of gas according to various reactor geometries. For example, in some embodiments, the gas injection port 905 receives between 0.5 and 20 standard liters per minute (SLPM) of hydrocarbon gas. A dielectric sheath 130 electrically isolates the upper electrode 110 from the reactor body 940.

A first conductive liquid injection port 120A is configured to receive a conductive liquid (not depicted) to pass the conductive liquid along the outer wall (e.g., sidewall 935) of the reactor. A liquid channel 910, internal to the reactor, can cause the liquid to tangentially swirl along the sidewall 935 thereof. The first conductive liquid injection port 120A can receive a conductive liquid at a rate of about 0.1 to 20 SLPM. A second conductive liquid injection port 120B is configured to receive a conductive liquid for down electrode flow and cooling, at least a portion of which may vaporize or ionize in the reactor. The second conductive liquid injection port 120B can receive a conductive liquid at a rate of about 0 to 100 standard cubic centimeters per minute (SCCM).

In some embodiments, the chamber can include various portions which are selectively coupled, such as by the depicted holding pins 920. The removal of holding pins can allow the reactor to be opened (e.g., for service such as periodic de-fouling). A plurality of permanent magnets 925 are disposed around the sidewall 935 of the reactor. The plurality of permanent magnets 925 can generate inter-reactor magnetic fields of about 100 gauss to 5000 gauss. In various embodiments, stronger, weaker, or variable magnets may be employed (e.g., electromagnets). The magnets 925 can, in combination with the electric field, cause the plasma to swirl which may increase and efficiency of the reactor due to increased reactions. The magnetic field can reduce blow-by and increase a quantity of non-thermal plasma. A water outlet valve 915 can release water from the reactor. Referring now to FIG. 9B, an isometric view of the hydrocarbon reactor of FIG. 9A is provided, in accordance with some embodiments. A gas outlet valve 930 can cause gas to be removed from the reactor to control a pressure thereof, or to harvest the gas. The gas may be refined (e.g., high in H₂) relative to the hydrocarbon gas input into the reactor.

The following include potential embodiments of the disclosed approach, representative of other examples that are not intended to be limiting in any way:

Embodiment A1: A multiphase non-equilibrium plasma hydrocarbon reactor comprising: a first electrode, configured to receive a first conductive liquid from a first injection port, and energize said first conductive liquid to a first voltage; and a second electrode situated a distance from the first electrode, the second electrode configured to receive a second conductive liquid from a second injection port, and energize said second conductive liquid to a second voltage such that a difference between the first voltage and the second voltage exceeds a dielectric breakdown of a gas disposed within the reactor for the distance.

Embodiment A2: The reactor of Embodiment A1, further comprising a gas injection port configured to deliver the gas to the hydrocarbon gas reactor.

Embodiment A3: The reactor of Embodiment A2, wherein the gas injection port is one of the first or second electrodes.

Embodiment A4: The reactor of any of Embodiments A1-A3, wherein the gas disposed within the reactor is a non-oxidizing gas comprising hydrocarbons.

Embodiment A5: The reactor of Embodiment A4, wherein the hydrocarbons comprise natural gas.

Embodiment A6: The reactor of any of Embodiments A1-A5, wherein a dielectric sheath, in conjunction with the first injection port, delivers the first conductive liquid to the first electrode.

Embodiment A7: The reactor of any of Embodiments A1-A6, further comprising a first outlet vent for the gas, and an ignition source configured to ignite the vent gas.

Embodiment A8: The reactor of any of Embodiments A1-A7, further comprising a bypass vent, configured to vent the gas prior to its introduction to the reactor.

Embodiment A9: The reactor of any of Embodiments A1-A8, further comprising a powered electrical generator, configured to receive hydrogen generated within the reactor to generate electrical energy.

Embodiment A10: The reactor of Embodiment A9, wherein the powered electrical generator comprises at least one of a pressure swing absorption (PSA) system, a temperature swing absorption (TSA) system, a membrane purifier, or a dryer purification system.

Embodiment A11: The reactor of any of Embodiments A1-A10, wherein the reactor is configured to generate swirling of radial plasma and liquid along an interior surface of a sidewall thereof.

Embodiment A12: The reactor of Embodiment A11, wherein the reactor includes a plurality of magnets disposed around an exterior surface of the sidewall thereof.

Embodiment A13: The reactor of any of Embodiments A1-A12, wherein the reactor is configured to adjust a flow rate of the first conductive liquid or the second conductive liquid based at least in part on a conductivity of the respective conductive liquid.

Embodiment B1: A system comprising: a plasma hydrocarbon reactor comprising: a first injection port configured to deliver a first conductive liquid at a first electrode; a second injection port configured to deliver a second conductive liquid at a second electrode that is a distance from the first electrode; and a gas injection port configured to deliver a hydrocarbon gas to the plasma hydrocarbon reactor; and a controller configured to generate, via a power supply, an electric field between the first and second electrodes.

Embodiment B2: The system of Embodiment B1, wherein the first injection port and the second injection port are different ports.

Embodiment B3: The system of either Embodiment B1 or B2, wherein the gas injection port is one of the first or second electrodes.

Embodiment B4: The system of any of Embodiments B1-B3, further comprising: a plurality of magnets disposed around an exterior surface of a sidewall of the multiphase non-equilibrium plasma hydrocarbon reactor.

Embodiment B5: The reactor of any of Embodiments B1-B4, wherein the controller is further configured to generate swirling of radial plasma in combination with the electric field between the first and second electrodes.

Embodiment C1: A method comprising: receiving, by a hydrocarbon reactor, a first conductive liquid at a first injection port; receiving, by the hydrocarbon reactor, a second conductive liquid at a second injection port, the second conductive liquid separated from the first conductive liquid by a distance; receiving, by the hydrocarbon reactor, a hydrocarbon gas; and energizing the first conductive liquid to a first voltage and the second conductive liquid to a second voltage such that a difference between the first voltage and the second voltage exceeds a dielectric breakdown of the hydrocarbon gas.

Embodiment C2: The method of Embodiment C1, further comprising: receiving, from the reactor, a conductive liquid therefrom; separating a first portion of conductive particles from the conductive liquid; and thereafter, injecting the separated conductive liquid into the reactor.

Embodiment C3: The method of either Embodiment C1 or C2, further comprising: receiving, from the reactor, the second conductive liquid; cooling, by a heat exchanger, the second conductive liquid; and injecting cooled second conductive liquid into the reactor.

For the purposes of this disclosure and unless otherwise specified, “a” or “an” means “one or more.” As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The embodiments, illustratively described herein may suitably be practiced in the absence of any element or elements, limitation or limitations, not specifically disclosed herein. Thus, for example, the terms ‘comprising,’ ‘including,’ ‘containing,’ etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase ‘consisting essentially of’ will be understood to include those elements specifically recited and those additional elements that do not materially affect the basic and novel characteristics of the claimed technology. The phrase ‘consisting of’ excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and processes within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular processes, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group, with regard to the reactor design, the chemical species thereof, etc.

As will be understood by one skilled in the art, for any and all purposes, particularly in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as ‘up to,’ ‘at least,’ ‘greater than,’ ‘less than,’ and the like, include the number recited and refer to ranges which can be subsequently broken down into sub-ranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

1. A multiphase non-equilibrium plasma hydrocarbon reactor comprising:
a first electrode; and
a second electrode situated at a distance from the first electrode;
wherein at least one of the first electrode or the second electrode is configured to receive a conductive liquid from a corresponding injection port, and energize said conductive liquid to a voltage differential between the first and second electrodes that exceeds a dielectric breakdown of a gas disposed within the reactor for placement between the first and second electrodes.

2. The reactor of claim 1 further comprising a gas injection port configured to deliver the gas to the hydrocarbon gas reactor.

3. The reactor of claim 2, wherein the gas injection port is one of the first or second electrodes.

4. The reactor of claim 1 wherein the gas disposed within the reactor is a non-oxidizing gas comprising hydrocarbons.

5. The reactor of claim 4 wherein the hydrocarbons comprise natural gas.

6. The reactor of claim 1 wherein a dielectric sheath, in conjunction with the injection port, delivers the conductive liquid to the corresponding electrode.

7. The reactor of claim 1 further comprising a first outlet vent for the gas, and an ignition source configured to ignite the vent gas.

8. The reactor of claim 1 further comprising a bypass vent, configured to vent the gas prior to its introduction to the reactor.

9. The reactor of claim 1 further comprising a hydrogen powered electrical generator, configured to receive hydrogen generated within the reactor to generate electrical energy.

10. The reactor of claim 9 wherein the hydrogen powered electrical generator comprises at least one of a pressure swing absorption (PSA) system, a temperature swing absorption (TSA) system, a membrane purifier, or a dryer purification system.

11. The reactor of claim 1, wherein the reactor is configured to generate swirling of radial plasma and liquid along an interior surface of a sidewall thereof.

12. The reactor of claim 11, wherein the reactor includes a plurality of magnets disposed around an exterior surface of the sidewall thereof.

13. The reactor of claim 1, wherein the reactor is configured to adjust a flow rate of the conductive liquid based at least in part on a conductivity of the conductive liquid.

14. A system comprising:
a plasma hydrocarbon reactor comprising:
a first injection port configured to deliver a first conductive liquid at a first electrode;
a second injection port configured to deliver a second conductive liquid at a second electrode that is at a distance from the first electrode;
a gas injection port configured to deliver a hydrocarbon gas to the plasma hydrocarbon reactor; and
a controller configured to generate, via a power supply, an electric field between the first and second electrodes.

15. The system of claim 14, wherein the first injection port and the second injection port are different ports.

16. The system of claim 14, wherein the gas injection port is one of the first or second electrodes.

17. The system of claim 14, further comprising:
a plurality of magnets disposed around an exterior surface of a sidewall of the plasma hydrocarbon reactor, wherein the controller is further configured to generate swirling of radial plasma in combination with the electric field between the first and second electrodes.

18. A method comprising:
receiving, by a hydrocarbon reactor, a first conductive liquid at a first injection port;
receiving, by the hydrocarbon reactor, a second conductive liquid at a second injection port, the second conductive liquid separated from the first conductive liquid by a distance;
receiving, by the hydrocarbon reactor, a hydrocarbon gas; and
energizing the first conductive liquid to a first voltage and the second conductive liquid to a second voltage such that a difference between the first voltage and the second voltage exceeds a dielectric breakdown of the hydrocarbon gas.

19. The method of claim 18, further comprising:
receiving, from the reactor, a conductive liquid therefrom;
separating a first portion of conductive particles from the conductive liquid; and thereafter,
injecting the separated conductive liquid into the reactor.

20. The method of claim 18, further comprising:
receiving, from the reactor, the second conductive liquid;
cooling, by a heat exchanger, the second conductive liquid; and
injecting cooled second conductive liquid into the reactor.
